(19) United States
(12) Patent Application Publication
(10) Pub. No.: US 2012/0304801 A1
(43) Pub. Date: Dec. 6, 2012

(54) VEHICLE LEVER

(76) Inventor: Jean L'ECUYER, Vaudreuil-Dorion (CA)

(21) Appl. No.: 13/485,169

(22) Filed: May 31, 2012

Related U.S. Application Data
(60) Provisional application No. 61/491,440, filed on May 31, 2011.

(51) Int. Cl. B62K 23/06

(52) U.S. Cl. 74/523; 74/551.8

(57) ABSTRACT

A lever mountable to a handle bar of a vehicle, manipulated by at least one finger of a rider and having an arm with a distal end and a proximal end. The arm extends away from the handle bar, and the proximal end connects to the handle bar. At least one finger contour is located on the arm between the distal and proximal ends, and follows at least one finger to allow the at least one finger of the user to manipulate the arm. The lever also has a retainer located near at least one finger contour, and retains the fingers on the arm. The finger contour can contour at least two fingers. The retainer projects away from the arm and can be curved so as to secure the fingers to the arm. A handlebar of a vehicle having a lever as described is also claimed.

### CROSS-REFERENCE TO RELATED APPLICATIONS

This application claims priority under 35USC§119(e) of U.S. provisional patent application 61/491,440 filed on May 31, 2011, the specification of which is hereby incorporated by reference.

### BACKGROUND OF THE INVENTION

The present invention relates to a vehicle lever and, more particularly, to a vehicle including the vehicle lever. More particularly, the present invention relates to an improved lever for receiving the fingers of a user for braking purposes or to activate the clutch and/or gears.

Known in the art are various levers used on motorcycles, bicycles (hereinafter referred to as “cycles”), or other vehicles to either apply the brakes or to change the clutch or gears.

These levers are generally situated on the handle bar of the cycle, with the left and right side of the handle bar each having at least one lever. The rider activates by compressing the lever whenever he or she wants to activate the brakes of the cycle, or in the case of a clutch/gear lever, when the rider wants to activate the clutch/gears. Similar levers exist and are used on all-terrain vehicles (ATVs), on scooters, and on other vehicles.

Also known in the art are the substantial drawbacks associated with such conventional levers, for example: a) for applications requiring repeated activation of the lever such as enduro motorcycling, dirt biking, or mountain bicycling, the rider's fingers can become easily fatigued; b) compressing the lever can crush those fingers not on the lever itself, creating discomfort and an unwelcome diversion for the rider; c) conventional levers are not able to prevent the rider's fingers from sliding off the lever; d) in case of a fall, conventional levers can trap the fingers on the lever, and those beneath the lever, between the lever and the handle bar; e) when a motorcycle's clutch is hot, conventional clutch levers can be difficult to operate due to their limited range of lever movement; f) conventional levers have limited travel room (i.e. they cannot be fully compressed) because they can trap fingers between the lever and the handle bar; etc.

### SUMMARY OF THE INVENTION

Hence, in light of the aforementioned, there is a need for an improved lever which, by virtue of its design and components, would be able to overcome or at least minimize some of the aforementioned prior art problems.

According to a general aspect, there is provided a contoured lever which ergonomically accommodates and retains the user or rider's fingers in all driving conditions, while allowing the rider to apply the necessary force when manipulating the lever. In an embodiment, the lever is so contoured to accommodate the index and the middle fingers.

Indeed, according to a general aspect, there is provided a lever mountable to a handle bar of a vehicle for being manipulated by at least one finger of a user, the lever comprising:

an arm having a distal end and a proximal end and extending away from the handle bar, the proximal end being connectable to the handle bar and the distal end being a free end, the arm having at least one finger contour being defined therein between the distal and proximal ends, each finger contour being configured for at least partially contouring a corresponding finger engaged with the arm so as to allow the at least one finger to manipulate the arm; and a retainer located adjacent to the at least one finger contour, the retainer being configured for retaining the at least one finger of the user on the arm.

The lever can have a pivot assembly for pivotally connecting the arm to the handle bar. The pivot assembly can allow the arm to rotate or pivot relative to the handled bar, so as to be compressed or raised.

The lever can be mounted onto both the left and right side of the handle bar.

The arm can extend from the connection with the handle bar, then slope at an inward angle toward the handle bar, and then continue parallel to the handle bar.

The retainer may protrude in a direction away from the handle bar, and can be located at the distal end of the arm opposite to the pivot assembly. The retainer can also be curved toward or away from the proximal end so as to better retain the fingers on the arm. The retainer can also be curved so as to contour on one side the form of a finger, such as the middle finger, and so as to contour on the other side the form of the ring finger so as to provide a comfortable placement of the fingers. In an embodiment, the retainer is located adjacent to a distal one of the finger contours.

The at least two finger contours can be curved depressions defined in the arm for ergonomically receiving the at least two fingers, which are, in an embodiment, the index and middle fingers. In an embodiment, the finger contours are defined in the arm on a side opposed to the handle bar.

The length of the arm can be determined so that the appropriate force can be applied with only two fingers under all circumstances.

According to another aspect of the present invention, there is also provided a handle bar equipped with the above-mentioned lever.

According to yet another aspect of the present invention, there is also provided a vehicle (ex: motorcycle, bicycle, etc.) equipped with the above-mentioned lever and/or handle bar. In an embodiment, the vehicle is a straddle-type vehicle.

According to yet another general aspect, there is also provided a method of installing the above-mentioned lever onto a corresponding vehicle and/or handle bar.

According to yet another general aspect, there is also provided a kit with components for assembling the above-mentioned lever, handle bar, and/or vehicle.

According to yet another general aspect, there is also provided a set of components for interchanging with components of the above-mentioned kit.

According to yet another general aspect, there is also provided a method of assembling components of the above-mentioned kit and/or set.

The objects, advantages and other features of the present invention will become more apparent upon reading of the following non-restrictive description of embodiments thereof, given for the purpose of exemplification only, with reference to the accompanying drawings.

### BRIEF DESCRIPTION OF THE DRAWINGS

FIG. 1 is a perspective view of a lever mounted to a handle bar, according to an embodiment.

FIG. 2 is a side elevation view of the lever shown in FIG. 1.

FIG. 3 is a perspective view of the lever of FIG. 1.

FIG. 4 is another perspective view of the lever of FIG. 1.

FIG. 5 is a side elevation view of a lever in accordance with another embodiment wherein the lever includes three finger contours.

FIG. 6 is a side elevation view of a lever in accordance with another embodiment wherein the lever includes two retainers.

FIG. 7 is a perspective view of a lever being gripped by some fingers of a user.

FIG. 8 is a perspective view of the lever of FIG. 7 being compressed towards a handle bar by the fingers of a user.

### DETAILED DESCRIPTION OF THE PREFERRED EMBODIMENTS

In the following description, the same numerical references refer to similar elements. Furthermore, for the sake of simplicity and clarity, namely so as to not unduly burden the figures with several references numbers, not all figures contain references to all the components and features of the present invention and references to some components and features may be found in only one figure, and components and features of the present invention illustrated in other figures can be easily inferred therefrom. The embodiments, geometrical configurations, materials mentioned and/or dimensions shown in the figures are preferred, for exemplification purposes only.

Moreover, although the present invention was primarily designed for activating the brakes or changing the clutch/gears on a vehicle or “cycle”, it may be used with other types of vehicles, devices, and objects and in other fields. For this reason, expressions such as “clutch”, “gears”, “brake”, “cycle”, “rider”, “vehicle”, etc., as used herein should not be taken as to limit the scope of the present invention to vehicles, and includes all other kinds of objects and/or purposes with which the present invention could be used and may be useful.

Moreover, in the context of the present invention, the expressions “lever”, “handle”, “grip”, “clutch”, “shifter”, “cantilever”, and any other equivalent expressions known in the art will be used interchangeably. Furthermore, the same applies for any other mutually equivalent expressions, such as “arm”, “shaft”, “bar”, “boom” and “staff”, as also apparent to a person skilled in the art.

In addition, although the embodiments of the present invention as illustrated in the accompanying drawings comprises various components and although some of the embodiments of the lever as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the lever and corresponding parts, according to the present invention, as briefly explained and as can be easily inferred herefrom by a person skilled in the art, without departing from the scope of the invention.

Broadly described, the lever 10, as shown in the accompanying drawings, is a device for activating a brake and/or clutch/gear on a cycle, so as to provide the rider with a better and more ergonomic control of the cycle.

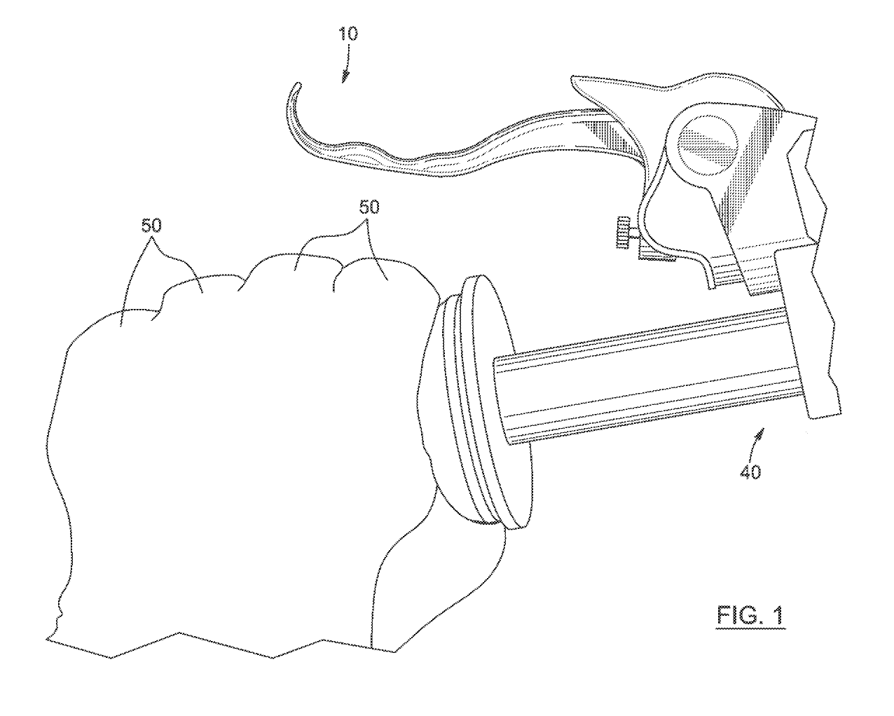

Referring now to the drawings and, more particularly, referring to FIG. 1, there is shown that the lever 10 is mountable to a handle bar 40 of a vehicle (not shown) to be manipulated by at least one of the fingers 50 of a user, such as the rider of the vehicle. The term “mountable” can mean that the lever 10 can be affixed securely to the handle bar 40, but also removed therefrom for the purposes of inspection, replacement, repair, etc. The handle bar 40 of the vehicle can be any device applied to, or affecting, the steering of the vehicle. As explained earlier, the term “vehicle” is not restricted to motorcycles or bicycles, and includes other vehicles that can be ridden such as tricycles, all-terrain vehicles (ATVs), snowmobiles, and personal watercraft. Indeed, one such vehicle having a handle bar 40 to which the lever 10 can be attached is a straddle-type vehicle, where the rider has one leg on either side of a vehicle frame. By “manipulated”, it is understood that the lever can be compressed or raised by the rider's fingers when riding the vehicle, either partially or fully, depending on various externalities such as riding conditions, power or braking requirements, etc. By “at least one finger”, it is understood that the lever 10 can be manipulated by one or more fingers 50 of the user. Therefore, when reference is made herein and in the accompanying drawings to “at least two fingers”, “both fingers”, “fingers”, etc., such references do not limit the lever 10 to being manipulated by a plurality of fingers 50, and it is understood that only finger 50 is necessary to manipulate the lever 10 in many circumstances.

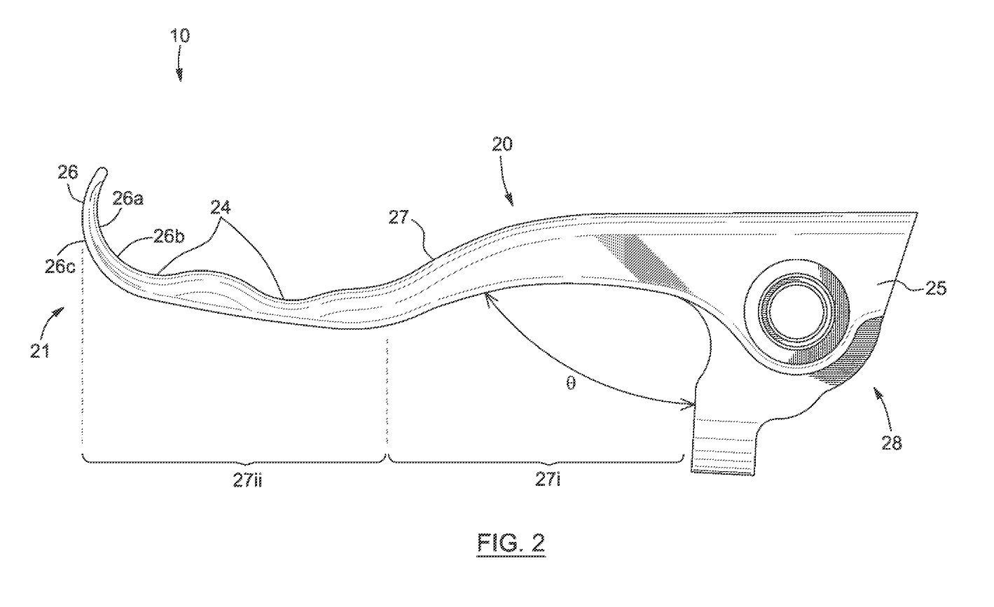

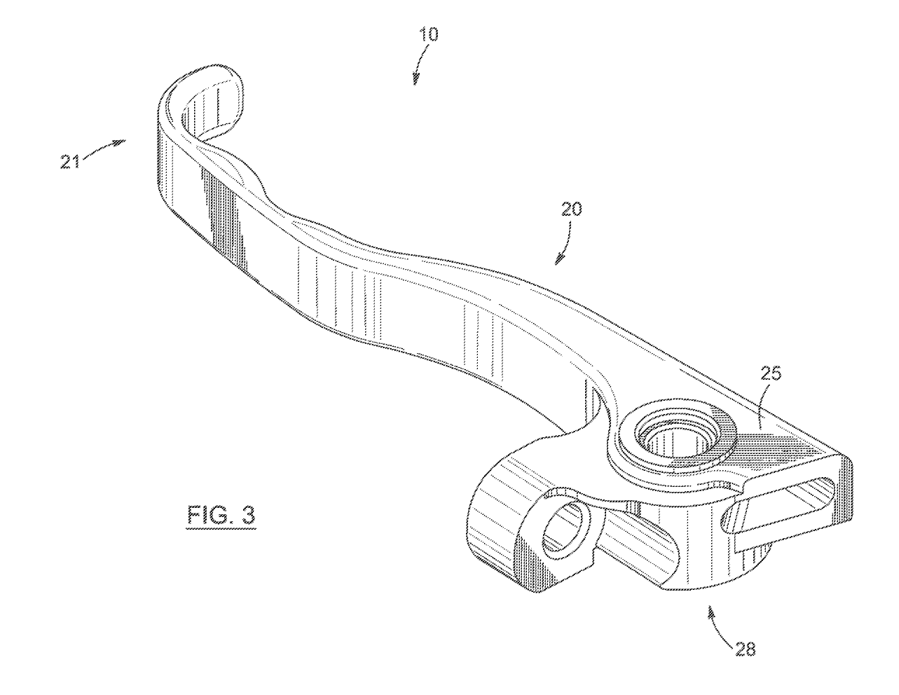

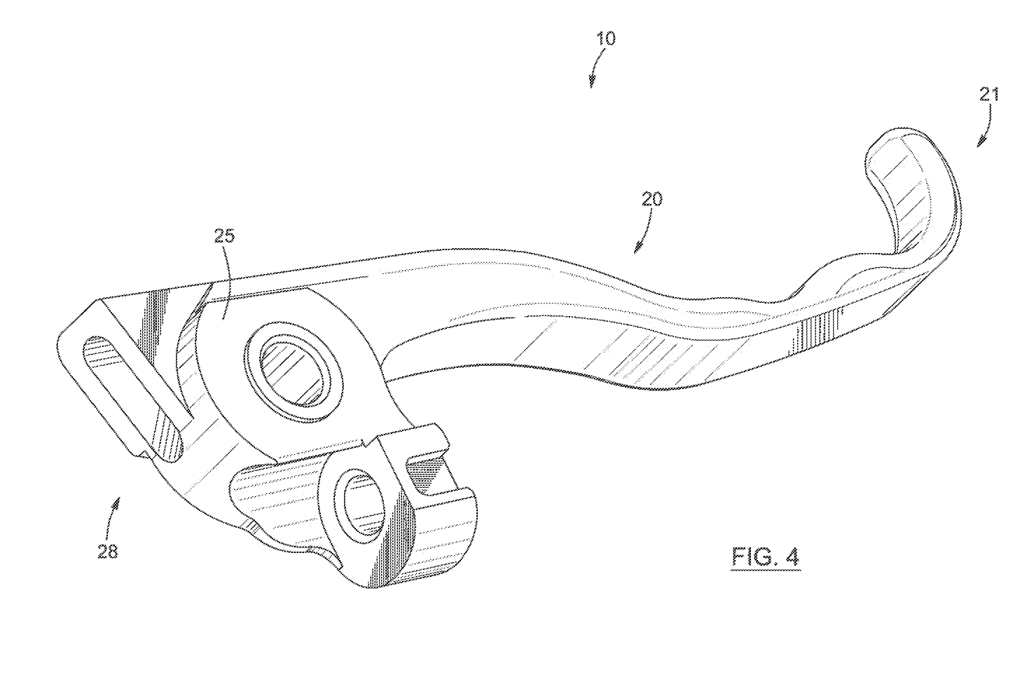

Referring to FIGS. 2 to 4, there is shown a first embodiment of the lever 10. The lever 10 has an arm 20 which has both a distal end 21 and a proximal end 28. The arm 20 serves as the main input means for the rider, who manipulates the arm to control braking, the clutch, gears, or other similar vehicle operations. The arm 20 is made of any suitable material capable of being repeatedly manipulated, of withstanding vehicle vibrations, or of meeting other design requirements. Such materials can include, but are not limited to, hard polymers and alloy metals. The dimensions and the exact design of the arm 20 can vary depending on many requirements such as, aesthetic constraints, production costs, space constraints, etc. As such, the configuration of the arm as shown in the attached Figures is exemplary, shown for the purposes solely of explaining and describing the features of the lever 10. It is therefore understood that the exact geometry, layout, design, and/or dimensions of the arm 20 may vary from the embodiments shown in the accompanying drawings.

The arm 20 extends away from the handle bar 40. The expression “extends away” means that the arm 20 does not form part of the handle bar 40, but is instead a separate component projecting away from the handle bar 40 at any suitable angle, as exemplified in FIG. 1. Returning to FIG. 2, the arm 20 is connectable to the handle bar 40 at the proximal end 28 of the arm 20. By “connectable”, it is understood that the arm 20 is securely affixed to the handle bar 40, or removed therefrom. The opposed end of the arm 20 is referred to herein as the distal end 21, and the distal end 21 corresponds to the part of the arm 20 that forms its outermost extremity. The term “proximal” and “distal” as used herein relate to the handle bar 40. As such, the proximal end 28 is that part of the arm 20 closest to the handle bar 40, whereas the distal end 21 is that part of the arm 20 furthest away from the connection with the handle bar 40.

In the exemplary configuration shown in FIG. 2, the arm 20 includes a pivot portion 25 and a handle portion 27. The pivot portion 25 is located near the proximal end 28 of the arm 20, and allows the arm 20 to be pivotally mounted to the handle bar 40. The handle portion 27 is connected to, and extends from, the pivot portion 25. The expression “extending from” when used to describe the handle portion 27 means that the handle portion 27 protrudes from its connection to the pivot portion 25 in a direction towards the distal end 21 of the arm 20. The handle portion 27 extends in “spaced relation” to the handle bar 40, which means that the handle portion 27 extends along the handle bar 40 while not entering in contact therewith. The handle portion 27 may also have a different relationship with the handle bar 40, depending on the configuration of the lever 10.

In the embodiment shown in FIG. 2, the handle portion 27 has a first section 27i and a second section 27ii. The first section 27i is located near the pivot portion 25 of the arm 20, and extends or dips towards the handle bar 40 so as to form an acute angle Θ with the pivot portion 25. The second section 27ii extends away from the first section 27i towards the distal end 21. The second section 27ii includes the at least one finger contour 24 and the retainer 26, as described below. The second section 27ii extends substantially parallel to the handle bar 40, and thus breaks from the acute angle Θ of the first section 27i.

In the embodiment shown in FIG. 2, the arm 20 also has at least one finger contour 24 defined in the arm 20. For the sole purposes of describing the at least one finger contour 24, reference will be made herein to “finger contours”, “at least two finger contours”, etc. and such reference does not limit the arm 20 to having a plurality of finger contours 24. This is more apparent when considering that the lever 10 herein described allows the rider to more stably and comfortably grip the handle bar 40 of the vehicle. A significant contribution to this stability and comfort is the fact that most of the rider's fingers 50 are able to continuously remain on the handle bar 40 because the lever 10 is configured so as to be manipulated by at least one finger 50 placed in at least one finger contour 24.

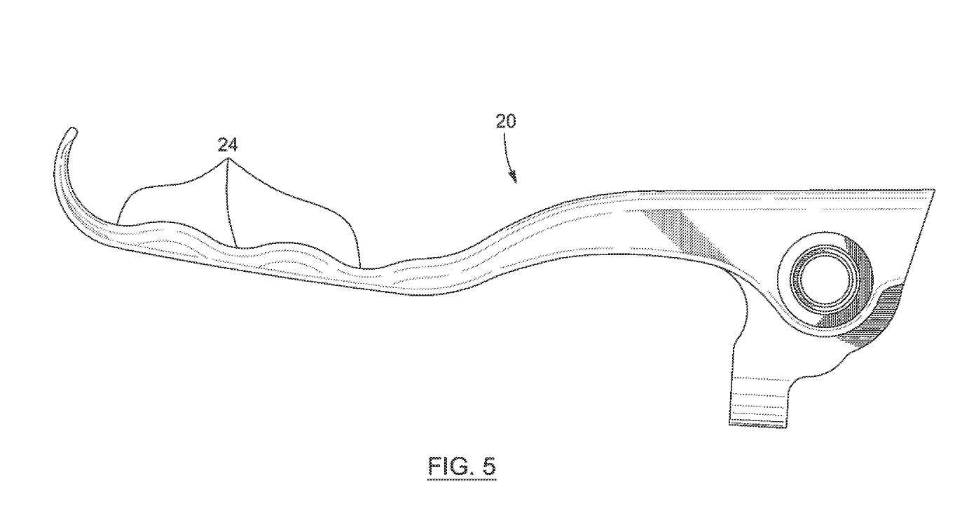

The finger contours 24 are curved depressions defined in the arm 20 and serve as areas in the arm 20 where the rider can comfortably and securely rest his fingers, and allow for the rider to manipulate the arm 20 while riding. These curved depressions render the arm 20 thinner when compared to adjacent sections of the arm 20 which have no finger contours 24. The finger contours 24 may be located on the side of the arm 20 which faces away from the handle bar 40, that is to say, on the side of the arm 20 with which the fingers 50 of the rider engage. In the embodiment shown, the finger contours 24 are located on the second section 27ii of the arm 20. In alternative embodiments, the lever 10 has at least two finger contours 24 defined in the arm 20, such as three finger contours 24, as shown in FIG. 5. By “at least two finger contours 24”, it is understood that the number of finger contours 24 can equal two finger contours 24, or more than two finger contours 24 up to five finger contours 24.

The number of finger contours 24 corresponds to only the index and middle fingers 50, or can also accommodate more than these fingers (for example, the index, middle and ring fingers). The finger contours 24 are disposed (i.e. located or positioned) on the arm 20 between the distal and proximal ends 21, 28. The exact location of the finger contours 24 can depend on a variety of factors such as the force required to manipulate the arm (i.e. finger contours 24 located further away from the proximal end 28 and the connection to the handle bar 40 can allow for a greater moment to be applied to the arm 20), rider comfort, design requirements, etc.

Each finger contour 24 contours at least one finger 50. The expression “contour” as used herein means that each finger contour 24 matches or follows the outline or disposition of at least a portion of the finger 50 resting therein. For example, if the index finger 50 is placed in a corresponding finger contour 24, this finger contour 24 matches or profiles the bottom and/or side portions of the index finger. In this exemplary configuration, another finger contour 24 accommodates the middle finger 50. Of course, the finger contour 24 need not perfectly match the profile of a given finger 50 contained therein, and it suffices that it approximates the profile of the finger 50 so as to permit it to comfortably rest and be secured in the finger contour 24, while still being able to manipulate the arm 20. In an alternative configuration, the finger contour 24 is configured to contain therein more than one finger 50, as shown in FIG. 5. Depending on the length of the arm 20 and the position of the finger contours 24, among other factors, one finger 50 may be sufficient to properly manipulate the arm 20. Conversely, two fingers 50 or more may be required.

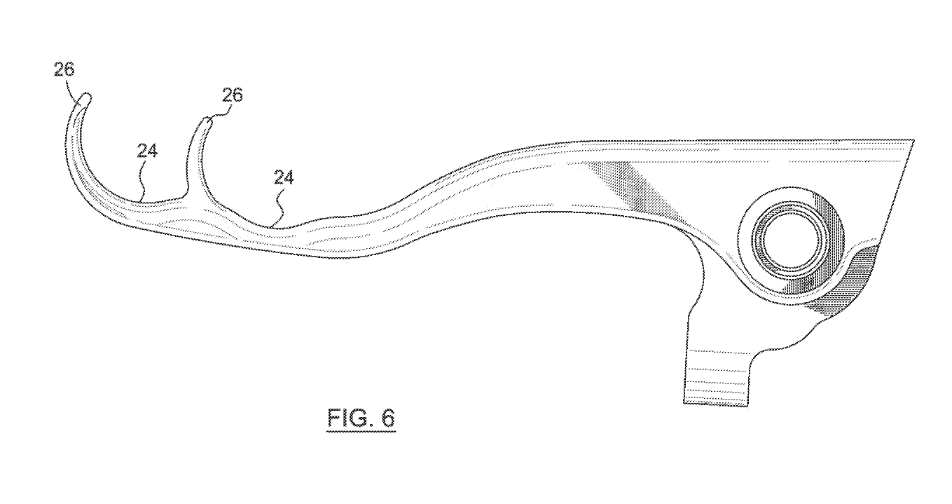

Returning to FIG. 2, there is shown that the lever 10 also includes a retainer 26. The retainer 26 helps to secure the finger(s) 50 onto the arm 20. The retainer 26 also prevents those fingers 50 not on the lever 10 from being crushed by the compression of the lever 10. The retainer 26 can also be a part of the arm 20 itself. Often during the riding of vehicles, disruptions such as bumps, vibrations, and turns dislodge the rider's fingers from the arm 20, or cause them to slide off. The retainer 26 can significantly reduce the occurrence of the fingers 50 coming off the arm 20. If necessary, the lever 10 can have more than one retainer 26 positioned to retain a specific finger 50, or all fingers 50, on the arm 20. For example, each finger contour 24 has its own retainer 26 located at a distal end of its respective finger contour 24, as shown in FIG. 6. Alternatively, and as exemplified in FIG. 2, the retainer 26 is positioned adjacent to the distal end 21 of the arm 20 (i.e. at an extremity of the arm 20), thus preventing all fingers 50 from sliding off the end of the distal end 21 of the arm 20.

In one exemplary embodiment, the retainer 26 extends in a direction away from the handle bar 40. This allows the retainer 26 to form a retainer contour 26a which contours a side of at least one of the fingers 50, such as the middle finger 50. The retainer contour 26a can be any cavity or depression which receives a finger 50 and curves or wraps around one of the sides of the finger 50, thereby ensuring that the finger 50 will not slide off the arm 20. For example, if the middle finger 50 is placed in the retainer contour 26a, the distal side of the middle finger 50 (i.e. the side facing the distal end 21) is enveloped or wrapped by the retainer contour 26a. The retainer contour 26a is near the distal end 21 of the arm 20, as shown in FIG. 2. Alternatively, the retainer contour 26a is near at least one finger contour 24, as shown in FIG. 6.

The retainer contour 26a may be curved. This curve opens towards the proximal end 28 of the arm 20, as shown in FIG. 2, thereby preventing the finger 50 from sliding off the arm 20. Alternatively, the retainer contour 26a can be curved away from the proximal end 28 (i.e. opening towards the distal end 21). In this configuration, the retainer contour 26a can still prevent the fingers 50 from sliding off the arm 20.

In an exemplary configuration, the retainer contour 26a profiles both the finger 50 nearest it on the proximal side, and the opposed finger on the other side of the retainer 26. Referring to FIG. 2, the retainer contour 26a has a proximal profile 26b and an opposed distal profile 26c. The proximal profile 26b contours the distal side of a finger 50 and the distal profile 26c abuts against the proximal side of another finger 50. This abutment of another finger 50 against the distal profile 26c allows the finger 50 to slide against the retainer 26 as the lever 10 is being compressed, which prevents the finger 50 as well as other, more distal fingers 50, from being crushed by the compression of the lever 10. Consider the example of the middle finger 50 resting in the retainer contour 26a. The proximal profile 26b contours the outermost or distal side of this finger 50, while the distal profile abuts against the innermost or proximal side of the ring finger 50. When the lever 10 is compressed, the ring finger 50 slides against the distal profile 26c of the retainer 26, and the ring finger 50 is thus prevented from sliding underneath the lever 10 as it is compressed. The pinky finger 50, being more distally situated than the ring finger 50, is similarly prevented from being crushed.

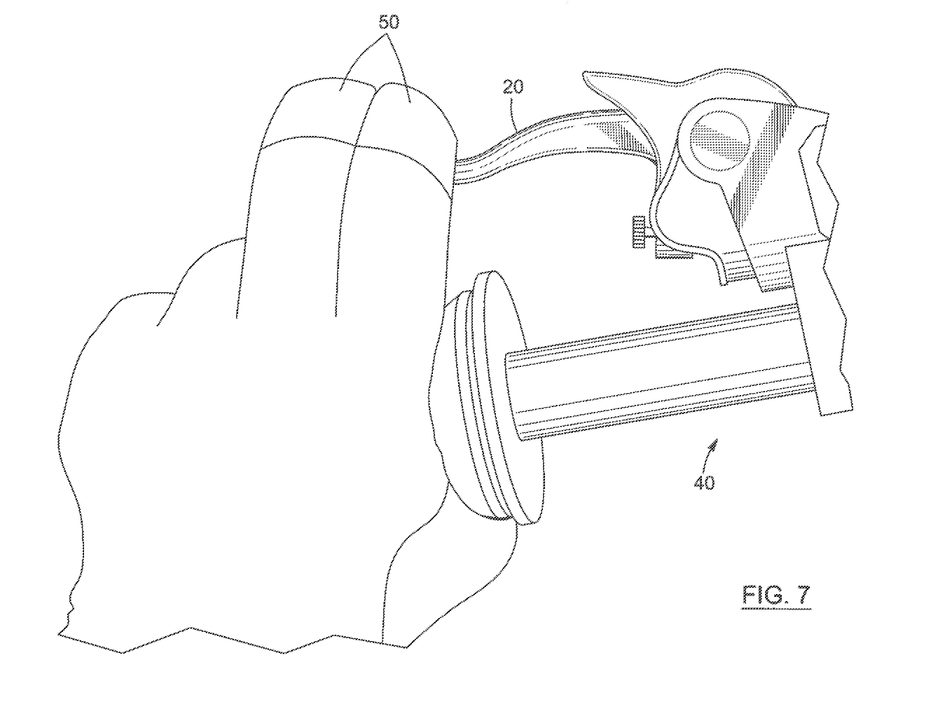

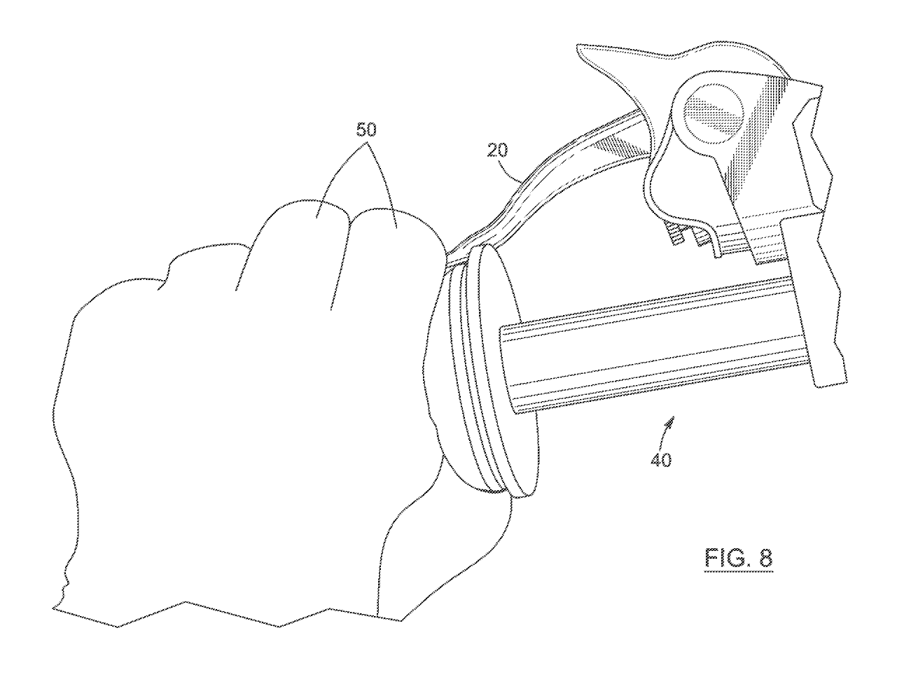

The arm 20, and therefore the lever 10, is operated between both multiple compressed configurations and a released configuration, as shown in FIGS. 7 and 8. In the compressed configuration as exemplified in FIG. 8, the arm 20 is pulled towards the handle bar 40 by the fingers 50 of the rider. The arm 20 may be compressed partially or at any given angle. In the released configuration, as exemplified in FIG. 7, the rider's fingers 50 are wrapped about the handle bar 40 or grip, or simply resting on the arm 20, and the arm 20 or lever 10 are raised. The other fingers ((thumb, pinky, and ring fingers) can be wrapped about the handle bar 40. In the compressed configuration, two fingers 50 are inserted into corresponding finger contours 24 and used to compress the arm 20, such as the index and the middle fingers. The other fingers (thumb, pinky, and ring fingers) are either wrapped around the handle bar 40 or simply free.

The arm 20 may be compressed with only two fingers 50. In order to increase the moment that the fingers 50 can apply around the pivot portion 25, the arm 20 can be lengthened and the finger contours 24 moved further away from the proximal end 28. This lengthening can be referred to as an activation distance, which is chosen so as to facilitate the manipulation of the arm 20 by the fingers 50.

Having discussed some of the principal components and features of the lever 10, some alternative embodiments will be further discussed hereinbelow.

The lever 10 can be mounted on only one side of the handle bar 40, and/or at least two levers 10 can be mounted on both the left and right side of the handle bar 40.

In an embodiment, the arm 20 begins at the connection of the lever 10 to the handle bar 40, extends away from the connection, and then slopes at an inward angle facing toward the handle bar 40. After an appropriate length, the arm 20 then continues away from the connection roughly in parallel to the handle bar 40. This portion of the arm 20 (i.e. the portion roughly parallel to the handle bar 40) contains at least two finger contours 24 for receiving at least two fingers 50, such as the index and middle fingers 50. The at least two finger contours 24 are curved or angled depressions which indent into the arm 20. The curvature or angle of the finger contours 24 should be determined and manufactured so as to most comfortably accommodate the fingers 50 of the rider and so as to ensure a proper grip of the lever 10 by the rider. In an embodiment, the finger contours 24 are sized, shaped and configured to accommodate the index and middle fingers 50. In an embodiment, the length of the arm 20 is determined so as to apply sufficient moment force at the connection in order to activate the brakes and/or clutch/gears under all conditions with the use of only two fingers 50.

The retainer 26 is curved or angled inward and/or outward (i.e. toward and away from the connection) and located at the end of the arm 20 opposite the connection. By being curved, the retainer 26 contours the entire middle finger 50 and prevents both the index and middle fingers 50 from sliding off the lever 10. Furthermore, the curvature or angle of the retainer 26 should be determined so as to contour the outer side of the middle finger 50, and to abut against the inner side of the ring finger 50 (the term “outer” meaning away from the connection and the term “inner” meaning toward the connection). The retainer 26 prevents the ring and little/pinkie fingers 50 from travelling between the lever 10 and the handle bar 40, thus becoming trapped and reducing the range of motion of the lever 10, among other disadvantages as better explained below. In another embodiment, the retainer 26 is not curved or angled but is instead a projection 26 projecting perpendicularly from the arm 20. In an embodiment, this projection 26 is projected in a direction away from the handle bar 40.

The lever 10 can also include a pivot assembly for pivotally or operatively connecting the arm 20 to the handle bar 40. The pivot assembly can be hollow and/or provided with appropriate cavities, conduits, passages, etc., for receiving cables which connect the lever 10 to the brake and/or clutch/gears. The pivot assembly is also mounted about a central pivot point which allows the lever 10 to rotate about said point.

Finally, the lever 10 and corresponding parts can be made of substantially rigid materials, such as metals, hardened polymers, composite materials, and/or the like, depending on the particular applications for which lever 10 is intended for and the different parameters in cause (force to be applied, weight restrictions, etc.).

As mentioned above, the above-described lever 10 allows the rider to activate the brakes and/or clutch/gears easily, while protecting her fingers during repeated use.

Another great disadvantage of traditional straight levers is that when the rider compresses them, the rider's ring and pinky fingers can become trapped beneath the lever and the handle bar 40. After repeated use, this can cause significant discomfort to the rider and can be reduce the range of motion of the lever itself. By contrast, the lever 10 includes a retainer 26 which prevents the ring and pinkie fingers from falling underneath the lever 10, thus ensuring comfortable and safe operation of the lever 10.

The lever 10 is also advantageous over levers known in the art because the profiled finger contours 24 provide an ergonomic support for the index and middle fingers so that the rider's fingers are always comfortable.

A further advantage is that the lever 10 will not hit or hurt the ring or pinkie fingers when compressed, which is desirable when riding in rough terrain while repeatedly using the lever 10.

Furthermore, when the lever 10 is fully compressed, the finger contours 24 allow the rider to securely and comfortable grab the handle bar 40 with all fingers. In case of fall, the two fingers (i.e. the index and middle fingers) can be easily freed from the lever 10 and not trapped between the lever 10 and the handle bar 40, thus freeing these fingers to be used to brace the rider and to prevent injury.

The lever 10 also overcomes some of the disadvantages associated with conventional levers used on motorcycles. When the clutch of the motorcycle becomes hot, the clutch lever often needs to be compressed with more force than two fingers can provide. The retainer advantageously slides between the middle finger and the ring finger, for example, and allows the lever 10 to go all the way to the handle bar, thus giving a much bigger range. The lever 10 has an arm which is sized so as to overcome this particular disadvantage, among others, so as to allow the lever 10 to be easily compressed with only one finger. This allows a normal change of the clutch to not affect the safety of the motorcycle. Furthermore, the fact that the retainer slides between fingers allows a much larger operational range, and gives an opportunity to extend the length of the lever 10 for the same operational angle. The lever 10 can therefore be operated with much less force, and cause less fatigue after repeated use.

It can therefore be appreciated that the lever 10 significantly reduces the squashing of fingers when the lever 10 is compressed, as well as the associated discomfort and blisters caused to the knuckles. It further reduces the occurrence of fingers being caught under the lever 10 if the rider falls off the vehicle. The at least one finger contour also features an ergonomic shape that fits the at least one finger comfortably, and the lever 10 is easier to squeeze to compress than known levers. Such a lever 10 leads to an increase in performance and a more enjoyable vehicle experience.

Of course, numerous modifications could be made to the above-described embodiments without departing from the scope of the invention, as apparent to a person skilled in the art.

The invention claimed is:

1. A lever mountable to a handle bar of a vehicle for being manipulated by at least one finger of a user, the lever comprising:
an arm having a distal end and a proximal end and extending away from the handle bar, the proximal end being connectable to the handle bar and the distal end being a free end, the arm having at least one finger contour being defined therein between the distal and proximal ends, each finger contour being configured for at least partially contouring a corresponding finger engaged with the arm so as to allow the at least one finger to manipulate the arm; and
a retainer located adjacent to the at least one finger contour, the retainer being configured for retaining the at least one finger of the user on the arm.

2. A lever according to claim 1, wherein the arm comprises a pivot portion pivotally mountable to the handle bar and a handle portion extending from the pivot portion in spaced relation to the handle bar and having a first section and a second section.

3. A lever according to claim 2, wherein the first section extends towards the handle bar, thereby forming an acute angle with the pivot portion.

4. A lever according to claim 2, wherein the second section comprises the at least one finger contour, extends away from the first section, and is substantially parallel to the handle bar.

5. A lever according to claim 2, wherein the retainer extends away from the second section of the arm, in a direction opposed to the handle bar, so as to form a retainer contour for contouring a side of the at least one finger of the user.

6. A lever according to claim 5, wherein the retainer contour extends at the distal end of the arm.

7. A lever according to claim 5, wherein the retainer contour is adjacent to a distal one of the at least one finger contour.

8. A lever according to claim 5, wherein the retainer contour is curved towards the proximal end of the arm so as to retain the at least one finger of the user on the arm.

9. A lever according to claim 5, wherein the retainer contour is curved away from the proximal end of the arm.

10. A lever according to claim 5, wherein the retainer contour has opposed proximal and distal profiles, the proximal profile contouring a distal side of the at least one finger, and the distal profile abutting against a proximal side of another finger.

11. A lever according to claim 1, wherein the at least one finger contour is two finger contours wherein a first one of the finger contours contours the index finger and a second one of the finger contours contours the middle finger engaged with the arm.

12. A lever according to claim 1, wherein the at least one finger contour comprises a curve-shaped depression.

13. A lever according to claim 1, wherein the at least one finger contour is defined on a side of the arm opposed to the handle bar.

14. A lever according to claim 1, wherein the arm is thinner in sections corresponding to the at least one finger contour than in sections of the arm immediately adjacent to the at least one finger contour sections.

15. A handle bar of a vehicle comprising:
a pivot assembly mountable to the handle bar;
a lever mountable to the pivot assembly and pivotable thereabout, the lever being configured for being manipulated by at least one finger of a user, the lever comprising: an arm having a distal end and a proximal end and extending away from the pivot assembly, the proximal end being connectable to the pivot assembly and the distal end being a free end, the arm having at least one finger contour being defined therein between the distal and proximal ends, the at least one finger contour being configured for at least partially contouring the at least one finger engaged with the arm so as to allow the at least one finger to manipulate the arm; and
a retainer located adjacent to the at least one finger contour, the retainer being configured for retaining the at least one finger of the user on the arm.

16. A handle bar according to claim 15, wherein the vehicle is a straddle-type vehicle.

17. A handle bar lever comprising:
an arm pivotally mounted to a handle bar and configurable between a released configuration and a plurality of compressed and partially compressed configurations, the arm having a pivot portion pivotally connected to the handle bar, a handle portion extending away from the pivot portion, and a finger retainer projecting from the handle portion away from handle bar, the handle portion having at least one finger contour defined therein in a side of the arm opposed to the handle bar for contouring at least one finger of a user engaged with the arm, the finger retainer being adjacent to the at least one finger contour.

18. A handle bar lever according to claim 17, wherein the at least one finger contour is defined between the finger retainer and the pivot portion of the arm.

19. A handle bar lever according to claim 17, wherein the at least one finger contour comprises a curve-shaped depression.

20. A handle bar lever according to claim 17, wherein in the released configuration, the at least one finger of the user is not engaged with the arm, and in the plurality of compressed and partially compressed configurations, the at least one finger is engaged with the at least one finger contour.

21. A handle lever according to claim 17, wherein the finger retainer extends away from a second section of the arm, in a direction opposed to the handle bar, so as to form a retainer contour for contouring a side of the at least one finger of the user.

22. A handle bar lever according to claim 21, wherein the retainer contour is curved towards a proximal end of the arm so as to retain the at least one finger of the user on the arm.

23. A handle bar lever according to claim 21, wherein the retainer contour has opposed proximal and distal profiles, the proximal profile contouring a distal side of the at least one finger, and the distal profile abutting against a proximal side of another finger.
